(19) United States
(12) Patent Application Publication
(10) Pub. No.: US 2005/0119817 A1
(43) Pub. Date: Jun. 2, 2005

(54) Procedure of steering and regulating the dynamic-drive of a vehicle

(76) Inventors: Christoph Pelchen, Tettnang (DE); Thomas Rosemeier, Friedrichshafen (DE); Andreas Thies, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/995,802

(22) Filed: Nov. 23, 2004

(30) Foreign Application Priority Data
Nov. 28, 2003 (DE) 103 55 701.6

(51) Int. Cl. G05D 1/00

(52) U.S. Cl. 701/71; 180/197

(57) ABSTRACT

A procedure is described for control and regulation of the dynamic-drive of a vehicle according to a set nominal value for the vehicle components affecting the dynamic-drive. The nominal value is set according to a driver's wish setting and with reference to a vehicle pattern stored in a control device. The measurable forces acting upon the vehicle are regulated and a controlled distribution of the longitudinal and lateral forces acting upon the tires of the vehicle is carried out among the tires.

The invention concerns a procedure of steering and regulating a dynamic-drive of a vehicle according to the type specifically detailed in the preamble of claim 1.

The dynamic-drive constitutes a branch of technical mechanics, that is, of the vehicle mechanics, which concerns itself with the forces acting upon a vehicle and the vehicle movements resulting therefrom. At the same time, the dynamic-drive is basically divided into longitudinal dynamics, transverse dynamics and vertical dynamics.

The longitudinal dynamics deals with the interaction of input or braking power on the wheels and with the traction resistances dependent on the aspect ratios and operating conditions. From the longitudinal dynamics important conclusions can thus be achieved, among others, for the fuel consumption, the acceleration capacity and the layout of the drive line and brake system.

The transverse dynamics analyzes the forces like side wind or centrifugal forces which deviate the vehicle from the travel direction. The forces can be compensated only by lateral guiding forces of the tires or wheels, the rubber-covered wheel rolling under a corresponding oblique angle relative to its median plane. The dynamic wheel load, the input and braking forces and the frictional properties of the road are also influential. Depending on the position of the center of gravity, on the frictional contact point of the wind forces, on the construction of the wheel suspension and on the tire quality, driving characteristics result which, together with the driver's steering reactions, allow conclusions regarding driving behavior, the ability to maintain the travel direction when driving straight ahead and the stability when cornering.

The vertical dynamics investigates the vertical forces and movements which are produced by the unevenness of the road and by the intermediary of tire and car suspension produced around the transverse axis lifting and pitch vibrations which are reduced by means of vibration dampers. When cornering, a shaking dependent on the axle arrangement results around the longitudinal axle and can be influenced by stabilizers.

By using electronic control systems, it is sought to improve the dynamic-drive, for example, it is possible to affect the longitudinal dynamics by an anti-blocking system; the transverse dynamics by a dynamic-drive regulation with targeted modulation of the yaw torque by a brake contact, and the vertical dynamics by reducing the tendency of the vehicle design to shake and a control of the damping properties by electronic running gear regulation.

A continuously increasing number of controllable components like active components in vehicles are provided as active components of a steering system, of the moving mechanics, or of the drive train, which affect the dynamic-drive of a vehicle. In the past, the vehicle components had been equipped with respective regulators. In order to be able to adaptively adjust the components affecting the dynamic-drive of a vehicle to the momentarily existing driving situation, a purpose in the practice has been changed over to provide a superposed control and/or regulation for some or all the affecting dynamic-drive components of a vehicle in order to be able to exhaust the potential of the entire vehicle system by central control of said separate units.

In some of the last mentioned controls known, a mathematical formula has been taken as point of departure, among others, in which the input signals of the active components are multiplied by a type of system matrix so as to be theoretically able to reproduce the actual vehicle behavior. The point of departure has been a simplified system matrix and a logical start vector for control of the vehicle components affecting the dynamic-drive by the aid of which a vehicle behavior or a dynamic-drive is theoretically reproduced. This result is evaluated and with reference to the evaluation, the control settings or the nominal value setting for the vehicle components are iteratively changed until a desired vehicle behavior is found.

This procedure is a disadvantage requiring an on-line optimization in real time, a high calculation capacity which is not available in motor vehicles. But to be able centrally to control the central control of the vehicle components affecting the dynamic-drive, the above described system matrix has to be extensively simplified. This simplification results in that the real vehicle system can be theoretically reproduced only in extensively limited form and a convergence is ensured only with limitations.

Another disadvantage is that a conclusion as to the required control of the vehicle components provided for achieving the desired behavior, which conclusion depends on a divergence found between a dynamic-drive determined by the reproduced real vehicle system and a set nominal value of the dynamic-drive which corresponds, for example, to a wished behavior dependent on the vehicle manufacturer, is possible only with high control and computation expenses.

Furthermore, underlying the procedures known from the practice for control of the dynamic-drive is the essential disadvantage that they are limited to the setting of input values for control of the vehicle components affecting the dynamic-drive without corresponding retroaction so that the dynamic-drive is essentially controlled.

Therefore, the problem on which this invention is based is to make a procedure available by means of which the dynamic-drive is controllable and regulatable so that when the dynamic-drive is adjusted, the real vehicle system can be more considerably taken into account and only a small calculation capacity is required.

This problem is solved with a procedure for control and regulation of the dynamic-drive having the features of claim 1.

With the inventive procedure, it is possible to implement control values for the components provided in a vehicle without requiring such calculation capacity and taking into account the actual vehicle system which affect the dynamic-drive such as steering system, moving gear and input elements in accordance with a driver's wish, such as a steering wheel angle, an accelerator pedal position, or the like, and a predefined vehicle pattern is stored in a control device.

This is achieved by the fact that in the inventive procedure the adjustment of the dynamic-drive of a vehicle is carried out in parallel by a regulation and a control, the sums of the forces and torques acting upon the vehicle and which can be measured or determined via the longitudinal and transverse acceleration or the yaw rate being regulated and the distribution of the longitudinal and lateral forces acting upon the individual wheels of the vehicle being controlled.

The inventive procedure, in addition, ensures that sought or desired driving behavior of a vehicle be achieved with certainty by an adequately adjusted dynamic-drive and a needed regulation portion is advantageously minimized as result of the inventive procedure.

By virtue of the inclusion, now possible, of the real vehicle system in the nominal value setting, the advantage also results that an equation system on which the vehicle pattern is based can be inverted whereby the control values of the vehicle components affecting the dynamic-drive can be easily determined in real time and with less computing work.

Other advantages and advantageous developments of the invention result form the claims and the embodiments described with reference to the drawing which shows:

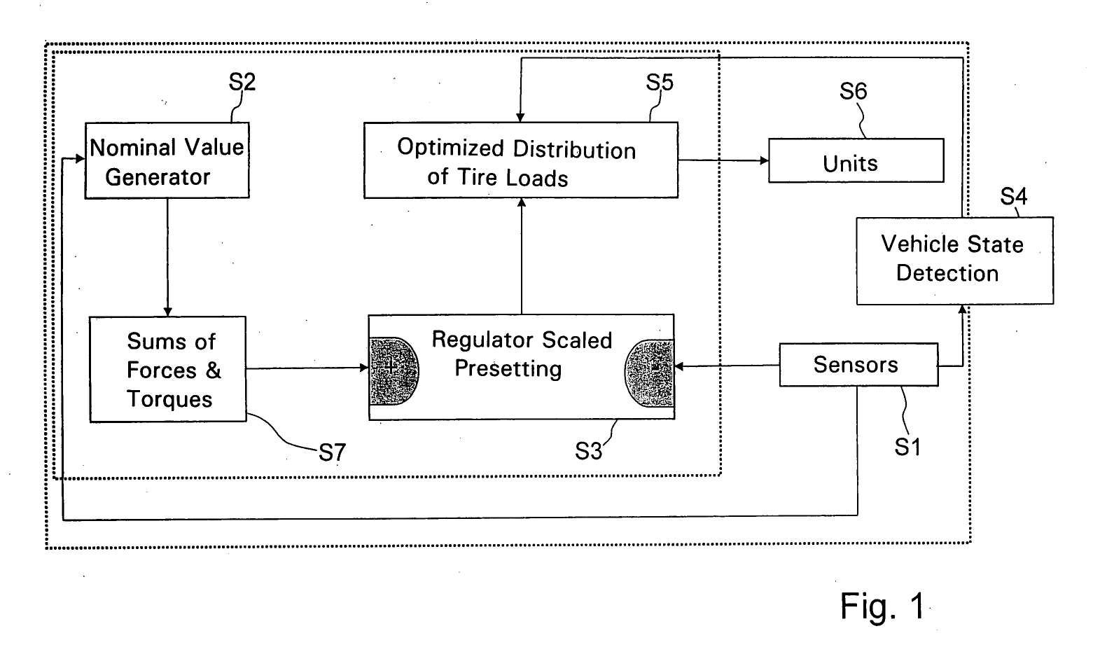

FIG. 1 is a simplified flow chart of an embodiment of the inventive procedure;

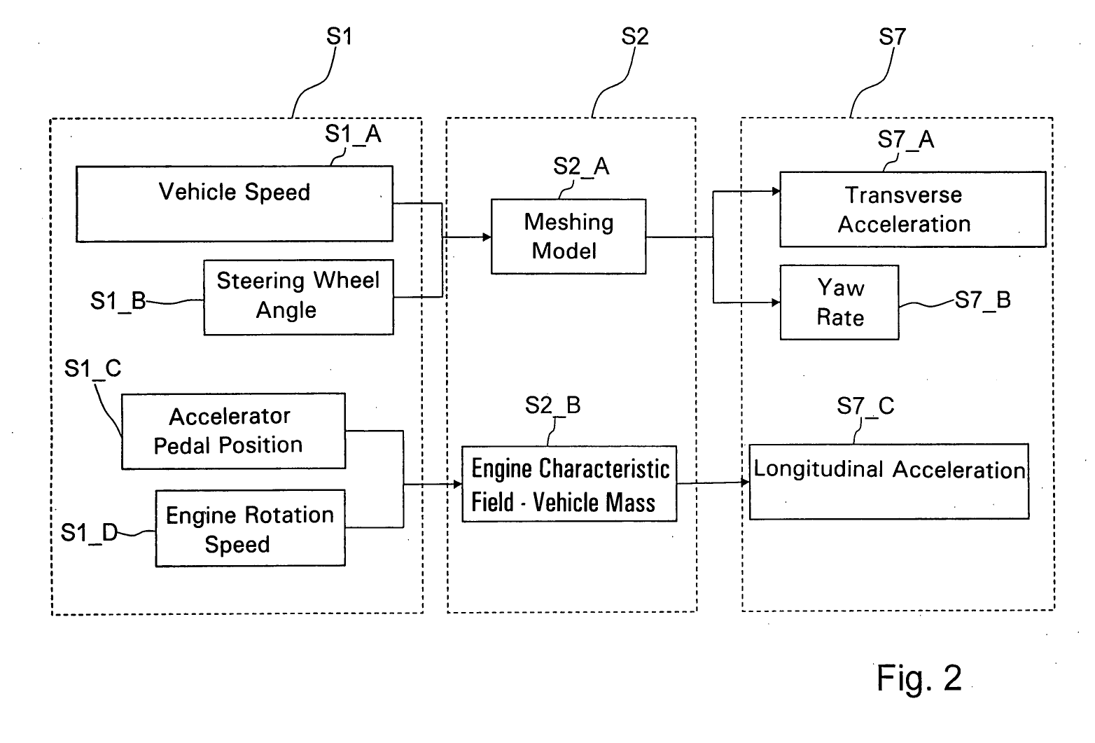

FIG. 2 is a detailed illustration of a generation of a wish setting of nominal values of a total yaw torque and of total lateral and longitudinal forces;

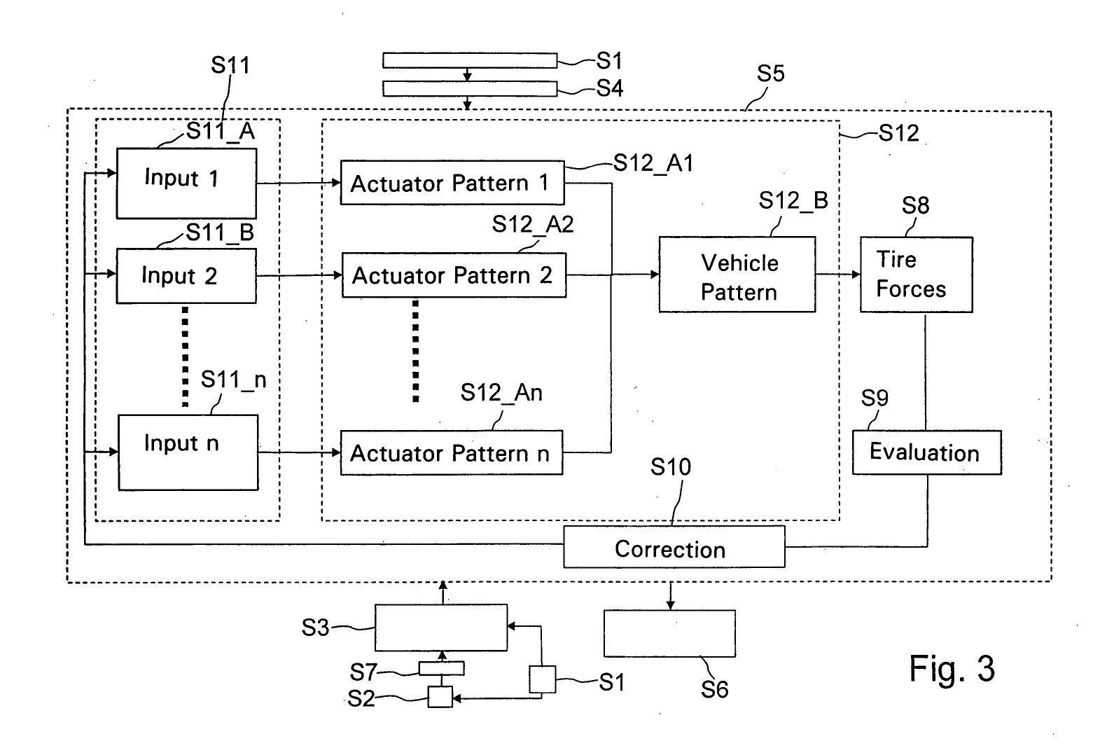

FIG. 3 is a first embodiment of the inventive procedure by means of which a set nominal value results for control of the vehicle components affecting the dynamic-drive; and

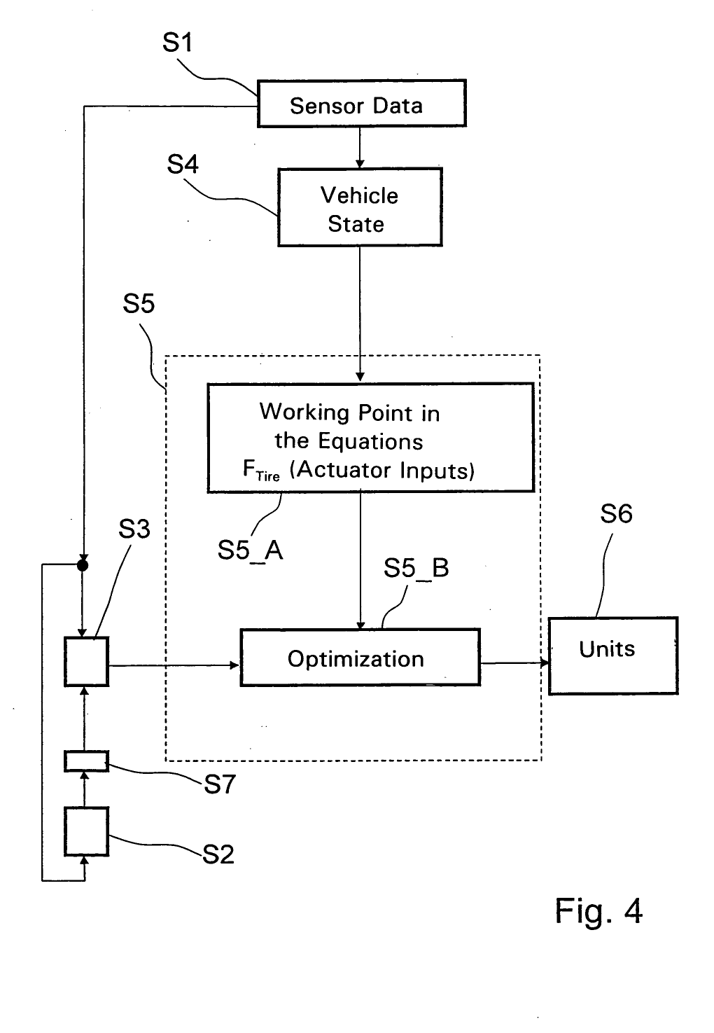

FIG. 4 is a second embodiment of the inventive procedure by means of which a set nominal value results for control of the vehicle components affecting the dynamic-drive.

Referring to FIG. 1, an abbreviated flow chart shows an embodiment of the inventive procedure for control and regulation of the dynamic-drive of a vehicle according to a set nominal value for the vehicle components affecting the dynamic-drive. By using the inventive procedure, the components or active components of a vehicle affecting the dynamic-drive such as a steering device, a moving gear, a drive train and the like, are adaptively controlled and regulated according to a driver's wish setting and to a vehicle pattern stored in a control device so that a desired driving behavior of the vehicle is obtained.

During a step S1, the most different operating parameters that characterize an actual operating state of the vehicle are determined and fed to a first vehicle pattern and to a second vehicle pattern, via sensors situated in the motor vehicle and known from the practice. The operating parameters determined in step S1 are, among others, a steering wheel angle, an accelerator pedal position, a ratio adjusted in a vehicle transmission and/or in an all-wheel transfer transmission, a vehicle inclination, operating data of an ABS system, measured values of an acceleration sensor and the like; there being calculated via the two vehicle patterns, according to the sensor values found and driver's wish setting, desired nominal values reproducing the real vehicle system for a whole yaw torque applied to the vehicle and for the whole lateral and longitudinal forces acting upon the vehicle.

In a step S2 are determined, by means of the first vehicle pattern, predefined or desired nominal values of the total yaw torque and of the total lateral and longitudinal forces acting upon the vehicle, the nominal values determined via the first vehicle pattern corresponding, for example, to a desired driving behavior of the vehicle preset by its manufacturer or a desired dynamic-drive of the vehicle representing a driving behavior typical of the manufacturer. The nominal values are then processed in a step S7 and fed to a regulator. In a step S3, the nominal values of the first vehicle pattern fed to the regulator are scaled and fed to a control according to the sensor data determined in step S1.

At the same time, the sensor data determined in step S1 are relayed to the second vehicle pattern as input data, the real vehicle system being modeled as realistically as possible during a step S4 according to the sensor data from step S1 by means of the second vehicle pattern. The sensor data are used in mathematical equation systems and so-called estimated actual values or theoretical nominal values of the dynamic-drive are determined which are to represent the real vehicle behavior or the actual dynamic-drive of the vehicle as precisely as possible.

Thereafter, in a step S5, a set nominal value is implemented for a control of the vehicle components affecting the dynamic-drive, according to the scaled nominal values of the dynamic-drive from step S3 and to the estimated actual values or theoretical nominal values of the dynamic-drive from S4 so that a desired dynamic-drive of the vehicle appears and these nominal requirements are distributed among the four wheels of the vehicle so that a suitably defined standard for the stress of the tires is distributed as uniformly as possible among all four tires, or the highest value reached on one tire for this standard is as small as possible. Based on the optimized distribution of the tire loads determined in step S5, such a control of the vehicle components affecting the dynamic-drive results in step S6 that the determined distribution of the tire loads sets in.

An optimization of the force reserves in the area of the tires is particularly achieved and an optimization of energy need and tire wear simultaneously results, due to the more favorable tire slip distribution. In addition, the distribution of the tire forces ensures that the sum of the respective forces or torques applied to the vehicle satisfy the nominal requirements and that upper adjustment limits of the vehicle components affecting the dynamic-drive is kept or not exceeded.

In case the last mentioned procedure should not be possible within the physical limits, a reduction of the engine torque and/or a brake contact is provided in order to prevent inadmissible values of the dynamic-drive and also driving situations critical to safety such as a brake out of the vehicle.

By taking the adjustment limits of the vehicle components affecting the dynamic-drive into account, it is also possible, in case of failure of one or more vehicle components affecting the dynamic-drive, to further control the vehicle logically since then the limits of the failed vehicle components can be set at zero and be no longer included in determining the dynamic-drive to be preset.

The use of the inventive procedure makes it also possible to regard the loading of a tire, for example, as a required frictional value and represent it in simplified form of the magnitude of a vector formed from the longitudinal and transverse forces applied to one tire divided by a wheel load or normal force applied to the tire observed. The concrete selection of the load standard thus advantageously makes a simple specific adaptation of the inventive procedure to the dynamic-drive philosophy of a vehicle manufacturer possible.

FIG. 2 shows a detailed illustration of a nominal value generation of a desired setting of nominal values of total yaw torque and of a total lateral force and longitudinal force wherein in step S1, which in FIG. 2 is divided into steps S1_A to S1_D, as sensor values are determined, by way of example, respective actual values of the vehicle speed of the steering wheel angle of the accelerator pedal position and of the engine rotational speed of a prime mover of the drive train of the vehicle.

The vehicle speed and the steering wheel angle, the same as the accelerator pedal position and the engine rotational speed, are subsequently fed as input values to both part steps S2_A and S2_B of step S2, In step S2 and in step S7, which is divided into part steps S7_A, S7_B ad S7_C, is determined according to a manufacturer presetting, a predefined or desired set nominal value which determines the vehicle transverse and longitudinal acceleration, the same as a yaw rate.

At the same time, the vehicle transverse acceleration and the yaw rate are determined by means of a known meshing pattern known from the practice, which is based on the modeling idea that the vehicle has been designed respectively on its front axle and on its rear axle with a single tire. It is obviously at the expert's discretion in part step S2_A to use for the first vehicle pattern any other vehicle patterns known from the practice by means of which a predefined or a desired driving behavior or a desired dynamic-drive of the vehicle can be theoretically reproduced or determined instead of the meshing pattern.

The vehicle longitudinal acceleration is calculated in part step S1_B according to the accelerator pedal position determined during part step A1_C and the engine rotational speed determined in part step S1_D, with the aid of an engine characteristic field stored in the control device and a predefined or an actually determined mass of the vehicle.

In FIG. 3 and FIG. 4 are respectively reproduced two graphically alternative embodiments of the procedure of step S5 shown in FIG. 1.

In the embodiment shown in FIG. 3, with reference to sensor data determined in step S1 which characterize a vehicle state, adequate assessments are implemented in relation to the vehicle longitudinal and lateral forces, the same as a total yaw rate and a specification of the set nominal value for the control parameters needed for conversion of the assessment of the vehicle components affecting the dynamic-drive.

For the purpose in a part step S8 of step S5, the tire longitudinal and transverse forces are first determined with reference to the set nominal value of step S3 and step S4 and then, in a part step S9 of step S5, they are compared with a fixed set nominal value of the tire forces, preferably according to a uniform tire distribution among the tires, and evaluated. Depending on the divergences eventually found during the evaluation in part step S9 of the tire forces calculated in part steps S8 from the set nominal value, in a part step S10 of step S5 changes are determined for the control parameters of the vehicle components affecting the dynamic-drive. The parameters constitute input values for a part step S11 of step S5, the control parameters in the individual steps S11_A to S11_n for the different components of the vehicle being processed as input values for the theoretical pattern of the vehicle components affecting the dynamic-drive.

Following this, the individual vehicle components affecting the dynamic-drive are theoretically reproduced in the separate steps S12_A1 to S12_An according to the input values from part step S11 and this simulation is fed as intermediate values to a third vehicle pattern of a part step S12 of step S5.

The third vehicle pattern corresponds here to the second vehicle pattern of step S4 which, with the aid of its input values, constitutes a vehicle system as near to reality as possible, it evidently being suitably at the expert's discretion to modify, in respect to the second vehicle pattern of step S4, the third vehicle pattern on which part step S12 is based in order to implement within less iteration steps the iterative specification of the tire longitudinal and transverse forces corresponding to the dynamic-drive desired.

The third vehicle pattern of part step S12_B, at the same time, takes into account every vehicle component affecting the dynamic-drive and reproduced as model. The reactions of the vehicle components affecting the dynamic-drive and reproduced as model in the individual steps S12_A1 to S12_An are used in the individual step S12_B of part step S12 to reproduce the whole real vehicle system, there being determined during the individual step S12_B the values required for determining the tire forces in step So which are now again calculated by the third vehicle pattern in another iteration loop according to the modeling of the vehicle system.

Thereafter, the latest found tire forces are evaluated in step S9 with regard to an optimized distribution of the tire forces among the preferably four tires of the vehicle. The stress of the four tires, at the same time, has to be distributed as uniformly as possible among all four tires or the highest value reached in one tire for this standard must be as small as possible. Besides, an optimization of the force reserves in the tires should be effected so that, by virtue of a favorable wheel slip distribution, there also sets in an optimization of energy need and tire wear. The divergences from the desired distribution are converted in part step A10 to corresponding changes of the control values for the individual steps S11_A to S11_n of the vehicle components affecting the dynamic-drive.

Further referring to FIG. 4, it shows a partial procedure of the inventive procedure alternative to the procedure shown in FIG. 3 and in which there is also found in step S4 for each tire an oblique angle, a road frictional value and a tire slip which are used for the optimization of the tire load distribution in step S5. This means that to the step S5 shown in FIG. 4 there are, likewise, first fed as input values during step S1 sensor data and actual values of the vehicle components affecting the dynamic-drive, the same as the vehicle longitudinal and lateral forces and the total yaw rate.

With the aid of the data found in step S4 concerning the vehicle state, in a part step S5A, with reference to tire characteristic lines stored in the control device, the actual working points of the four tires are determined and the characteristic lines linearized in the working point determined of one of each tire by specification of the gradients of the tire characteristic line in the working point of the tire. For determining the tire forces, the equations are converted prior to the system implementation so that the input values for control of the vehicle components affecting the dynamic-drive are made directly to cohere with the tire forces. This means that the tire forces can be determined by this procedure with the aid of gradients of the tire characteristic lines actually determined in the vehicle for each calculation step with reference to the converted equations which are in direct functional interrelation with the input values of the vehicle components affecting the dynamic-drive.

With these updated equations, the distribution of the tire forces among the individual tires is optimized in part step S5_B of step S5 with known mathematical methods and few requirements on the calculating capacity, the type of the mathematical relationship depending each time on the vehicle configuration which, in turn, determines the selection of the optimization procedure. The optimization of the control values for the vehicle components affecting the dynamic-drive is carried out here from a median value, according to a uniform tire load or a divergence of the individual tire forces, taking marginal conditions into consideration as physical limits of the tire forces and upper adjustment limits of the vehicle components affecting the dynamic-drive.

With the above described inventive procedure, on one hand, a greater advantage in safety is achieved, since the tire forces can be determined and the dynamic-drive preset in a manner such that the wheels, as interface between vehicle and soil, are removed as far as possible from their saturation thus having as great as possible force reserves.

By the inventive procedure is further obtained a great agility of the vehicle, since the distribution of the tire forces among the individual tires of the vehicle can be adjusted so that, on one hand, an increased safety in driving is achieved and, on the other, eventually existing tire force potentials can be better utilized.

The above described inventive procedure can further be used for many different vehicle configurations and, in addition, constitutes an easy adaptation to different vehicles. It is thus absolutely probable to control and regulate the dynamic-drive of a vehicle by means of the inventive procedure where the wheel loads, that is, the normal force acting upon the tire, cannot be affected for each wheel by a vehicle component. In this case, the wheel loads determined by approximation from different sensor data are considered as marginal conditions.

If the dynamic-drive of a vehicle is controlled and regulated by the inventive procedure, where at least one vehicle component is provided for individually affecting the wheel loads, these wheel loads, the same as the longitudinal and transverse forces of the tire, are subject to the inventive optimization and influenced as desired by adequate control of the vehicle components affecting the dynamic-drive within the given marginal conditions.

1-17. (canceled)

18. A method for control and regulation of the dynamic-drive of a vehicle according to a set nominal value for the vehicle components affecting the dynamic-drive which results depending on a set driver's wish and with reference to a vehicle pattern stored in a control device, measurable forces acting upon the vehicle are regulated and a controlled distribution of the longitudinal and lateral forces acting upon the vehicle is carried out.

19. The method according to claim 18, wherein the tire forces resulting from the dynamic-drive on the individual tires of the vehicle are distributed at least with approximate uniformity among the tires.

20. The method according to claim 18, wherein the tire forces are adjusted so that the sum of the tire forces correspond to a nominal requirement preventing that the upper adjusting limits of the vehicle components affecting the dynamic-drive be exceeded.

21. The method according to claim 20, wherein when finding nominal values of the set nominal value which are higher than the upper adjustment limits of the vehicle components affecting the dynamic-drive, one or more of an input torque of a prime mover of the vehicle is reduced and a brake engagement is implemented.

22. The method according to claim 18, wherein a standard of a load of a tire is assumed as required frictional value corresponding to the quotients from a magnitude of the vector resulting from a longitudinal and transverse force applied to a tire and a wheel load applied to the tire.

23. The method according to claim 18, wherein a first vehicle pattern is provided by means of which, according to actual values of the vehicle components affecting the dynamic-drive and a set driver's wish, nominal values of the dynamic-drive are determined which correspond to a predefined vehicle behavior.

24. The method according to claim 23, wherein the nominal values of the dynamic-drive are scaled in a regulator by means of actual values of the dynamic-drive, the scaled values of the dynamic-drive being used for determining the set nominal value.

25. The method according to claim 18, wherein a second vehicle pattern is provided by means of which a real vehicle behavior can be reproduced according to one or more of actual values and nominal values of the vehicle components affecting the dynamic-drive.

26. The method according to claim 25, wherein by means of the second vehicle pattern at least one oblique angle and a slip of a wheel, the same as a road frictional value, can be determined.

27. The method according to claim 25, wherein the scaled values of the dynamic-drive and the values determined via the second vehicle pattern and which characterize the vehicle behavior are used to determine the tire forces.

28. The method according to claim 27, wherein the tire forces are evaluated with regard to a divergence from a nominal setting of a sum of the tire forces and to a divergence of the determined distribution of the tire forces from a nominal distribution of the tire forces.

29. The method according to claim 28, wherein the set nominal value for control of the vehicle components affecting the dynamic-drive is changed in a manner minimizing the divergence between the determined distribution of the tire forces and the nominal distribution.

30. The method according to claim 29, wherein the tire forces are again determined and evaluated by means of a third vehicle pattern preferably corresponding to the second vehicle pattern and according to the changed set nominal value of the vehicle components affecting the dynamic-drive, there being determined a divergence of the distribution of tire forces found from the nominal distribution of the tire forces.

31. The method according to claim 28, wherein the optimization of the distribution of the tire forces is terminated when reaching a predefined limiting value of the divergences between the determined distribution of the tire forces and the nominal setting or when reaching a predefined loop number, the actual nominal values of the vehicle components affecting the dynamic-drive at the moment of terminating the optimization forming the set nominal value.

32. The method according to claim 27, wherein depending on the tire forces determined, a working point of a tire is determined with reference to a tire characteristic line stored in the control device.

33. The method according to claim 32, wherein the tire characteristic lines of each one of the tires are linearized at the working points determined and linearized functional relationship is inverted to determine the tire forces so that the set nominal value for control of the vehicle components affecting the dynamic-drive can be determined by the inverted functional relationship according to the tire forces found at the working points of the tire.

34. The method according to claim 33, wherein the set nominal value found for control of the components affecting the dynamic-drive is optimized depending on a sought uniform distribution of the tire forces and the optimized set nominal value for the control of the vehicle components affecting the dynamic-drive represents the set nominal value.
